(19) United States
(12) Patent Application Publication
(10) Pub. No.: US 2005/0077168 A1
(43) Pub. Date: Apr. 14, 2005

(54) Neutron activated and laser stimulated chemical luminescence and condensation for the mass production of diamond, carbon nanotube and other carbonaceous articles

(76) Inventor: Reginald B. Little I, Tallahassee, FL (US)

Correspondence Address: Reginald Bernard Little, 308 Great Lakes St, Tallahassee, FL, 32305, US

(21) Appl. No.: 10/874,411

(22) Filed: Jun. 23, 2004

Related U.S. Application Data
(60) Provisional application No. 60/482,145, filed on Jun. 24, 2003.

(51) Int. Cl. C01B 31/00

(52) U.S. Cl. 204/155; 204/157.15

(57) ABSTRACT

An apparatus for selective and massive synthesis of carbonaceous articles includes a chamber having at least one carbon and metal source, heating element, exciting laser, oscillator cavity, stimulating laser, magnet, pressure generator, and polarized neutron source. In operation, carbon precursors and possibly metal catalysts are heated and contacted with exciting laser, stimulating laser, neutron beam and pressure source while being confined within the laser cavity under the influence of the magnetic field. The resulting conditions cause efficient excitation, spin dynamics population inversion of carbon intermediates for efficient stimulated selective chemical condensation of diamond, CNT and other carbonaceous articles. The magnet, catalyst, pressure, polarized/unpolarized neutrons and polarized/unpolarized x-ray facilitate population inversion about desirable high spin carbon states. The pumping and stimulating lasers include but are not limited to x-ray, free electron, YAG systems.

### FIELD OF THE INVENTION

The present invention involves a method and apparatus for the massive and selective formation of diamond and CNT. The present invention has particular applicability in selectively producing such carbonaceous articles in high yield and throughput. The invention provides a more thorough efficient use of the energy of nuclear power plants by employing energetic neutrons from these plants to enhance the formation of these valuable carbonaceous products: diamond and CNT. The invention also makes use of laser technology in an innovative way by for the first time using the laser mechanism of excited atoms to concentration (population inversion) important (neutron activated) high spin (hybrid) carbon intermediates for stimulated selective photochemical condensation of these intermediates into massive amounts of diamond and/or CNT. Free electron lasers for x-ray excitation by polarized x-ray for carbon fixation. The invention further exploits laser technology to drive plasmons and phonons in catalyst for the controlled neutron/electron interaction for facile carbon rehybridization within and on the catalysts. The laser technology is important for exciting atoms, x-ray rehybridization, populational inversion and stimulated chemiluminescence of particular products. The invention makes use of magnetic technology in order to stabilize and confine high spin states of atoms with in a laser cavity and defining reaction zone. The field of this invention further defined by lasing cavity wherein chemistry may be driven to yield valuablke products of fullerenes, CNT and diamond. The field of this invention defined by x-rays, neutrons, magnets, laser technology is inclusive in unlimited manner to older methods and technologies of laser vaporization, arc vaporization, catalytic chemical vapor deposition, hot filament chemical vapor deposition, solid state processes, high pressure high temperature processes of making diamond and CNT. The new art's use of laser and neutron phenomena to generate high density of high spin carbon atoms for magnetic densification leads to lower pressure and temperature fabrication of diamond and CNT. The basis for using these various technologies rest upon the current use of the x-ray, neutron and magnet for analyzing these carbonaceous materials. In order to analyze, one has to interact with a system. Here it is reasoned that the same tools used to analytically interact may be used to stimulate processing of the materials. X-rays, neutrons, magnets, lasers, pressure and temperature interact in a specific fashion with diamond and various CNT sizes and helicities. By fine tuning these technologies this characteristic interaction is used here to control, stimulate and accelerate diamond and /or CNT growth.

### BACKGROUND

Carbonaceous materials possess a wide variety of applications due to their unique electronic structure and chemical bonding. Current interest in these materials reflect their unusual strength and toughness; their electric transport (CNT), their large thermal transport (CNT, diamond), their novel optical properties, their chemical stability and their storage capacity (CNT). It has been shown that these carbon-based materials provide high strength, low weight, stability, flexibility, good heat and electric conductivity and large surface area for a variety of applications.

The industrial potential of these materials encompasses many products ranging from nanoelectronic to composite bulky strong structures to ultra-fast optical switching devices to hydrogen fuel cells.

The best know techniques for fabricating CNT, fullerenes and diamonds involve the use of laser, arc and catalytic-thermal systems.

Even with these advancements of the older art more development is in order for more massive production of CNT and diamond to spur the growing carbon-based materials industry.

This invention makes use of these older systems and other systems as sources of carbon and metal atoms for neutron activated and optical stimulated chemical condensation of CNT and diamond.

X-rays, neutrons, magnetc, pressure and temperature are currently used to analyze the formation and properties of diamond and CNT. This invention makes use of these background technologies to control and accelerate the formation of these carbonaceous materials.

### BRIEF SUMMARY OF THE INVENTION

One of the improvements of the present invention is an apparatus for massively producing CNT and diamond in higher yield, purity, selectivity and efficiency.

Another improvement of the invention is an apparatus for massively producing CNT and diamond with less effort, expense and cost by making use of readily available neutron energy from radioactive stockpiles and x-ray photons from synchrotron facilities. The new art exploits neutron and photon effects for eliminating the high temperature and pressure conditions of older art with the needy discovered advantage of producing diamond and CNT with less effort.

Another improvement includes formation of single crystal diamond and control of CNT size and helicity.

Another improvement of the present invention is its applicability to most existing techniques (LV, AV, and CVD) for CNT and diamond production. This new art provides neutron and laser photons for use with current LV, AV and CVD techniques with the enhancement of the ability of these techniques for generating CNT and diamond. The enhancement is a result of the tight focus of energy and uniformly coherent energy provided by the neutrons and laser photons in comparison to heat and phonons in older art.

Another improvement of the present invention is its inherent capability for in-situ analysis of CNT and diamond products as they form. Such in-situ analysis if lacking by older art. Most existing analytic techniques (although limited) make use of laser photons for analysis. The high-energy (beyond U-V) photon absorbance and emission of carbon atoms complicates the spectroscopy. The rich vibrational character of graphite, CNT and diamond complicates the Raman and IR of the products. The x-ray and neutron scattering from this invention offers advantages beyond optical spectroscopy for probing, analyzing, manipulating, computerizing and feedback controlling the CNT and diamond production. In particular deep probing and in-situ observation for data collection for logic, reasoning, action, manipulation of process variables and feed-back control are feasible due to advantages provided by this new invention.

Additional improvements and other features of the present invention will be put forth in the description which follows and in part will be apparent to those having ordinary skill in the art upon examination of the following or may be learned from the practice of the present invention. The progress and improvements of the present invention may be realized and ascertained as outlined in the appended claims.

On basis of the present invention, the foregoing and other advantages are achieved in part by a new apparatus for producing CNT and diamond. The apparatus consists of a reaction chamber having at least one heating element, at least one port for introducing carbon and metal precursors and background gases, at least one port for exhaust gases. The heating element can be any element useful for heating the content of the reaction chamber and the ports can be a gas inlet and outlet. Metal catalyst (atoms, cluster, nanoparticles and/or macroparticles) may be disposed in the reaction chamber. At least one laser radiation source may be disposed to the reaction chamber for exciting, pumping and stimulating carbon and metal atoms. At least one magnetic field generator may be affecting the content of the reaction chamber for magnetic densification and stabilization. At least one device for affecting the internal pressure of the reaction chamber is involved. At least one laser cavity is arranged within the reaction chamber for optically inverting favorable carbon and metal intermediates. At least one neutron source is affecting the reaction chamber for intersystems crossing to favorable intermediates. The thermal energy, catalyst, laser fields, magnetic fields, and neutron bombardment facilitate the conversion of carbon precursors to diamond and/or CNT.

In accordance with the current inventive apparatus, a neutron source is positioned near the reaction chamber that is capable of magnetically interacting with the electrons of carbon and metal atoms within the reaction chamber. The unconfined, spin polarized (or un-polarized) neutrons from the neutron source are useful for affecting, detecting and altering the spin states of confined electrons of excited carbon and metal atoms as by substantially rehybridizing carbon and metal atoms atoms for enhanced formation of CNT and diamond articles from the precursors. Neutron fluxes greater than 10¹⁸ and less than 10⁵⁰/cm²-s. Indirectly, the neutrons also activate carbon rehybridization by activating metal atoms, thereby facilitating catalytic effects of the metal atoms on carbon atoms for super-catalytic effects. The apparatus of the current invention advantageously facilitates intersystem crossing of electronic states of carbon and metal atoms for the more efficient rehybridization of carbon atoms for the chemical condensation of sp² CNT or sp³ diamond articles. Devoping this according to . . . In accordance with the current inventive apparatus, an x-ray source such as free electron laser is positioned to irradiate the reaction zone of the oscillator cavity that contains the carbon and metal precursors. The xray intensity, wavelength, spatial and temporal extents are such to optimize the product formation.

In accordance with the current inventive apparatus, an optical oscillator cavity for pumping and populationally inverting carbon atoms is designed within the reaction chamber. A free electron laser may be used to provide polarized x-ray pulse and continuous for exciting carbon into specific states. YAG, Xicimer and other lasers may be used for operating the oscillator cavity. The oscillator cavity is useful for optically populating specific high spin excited carbon electronic states that preferentially condense into CNT or diamond. X-ray and neutrons create excited carbon and metal states in the oscillator cavity and invert about these intermediates. The high spin population also allows magnetic densification of these important intermediates.

In accordance with the current inventive apparatus, a magnetic generator is positioned about the reaction chamber that is capable of generating sufficient magnetic fields for confining the high density of high spin carbon and metal atoms produced by the neutrons and x-ray and optical cavity. The magnetic stabilization and densification facilitate the proximity for collisional condensation of diamond and CNT. DC and superconducting magnet technology may be used to generate sufficient fields.

Embodiments of the present invention include an apparatus comprising a reactive chamber, a x-ray and neutron sources, a catalyst source, a carbon precursor source (LV, AV or CVD), a heating device, a pressure device, lasers, a magnetic field generator and at least one internal laser cavity. The x-ray and neutron beam from the source is energetically tuned and focused so as to be contacted with the carbon and metal atoms to influence their electronic structures.

The nature of the catalyst disposed to the reaction chamber comprises any transition metal and/or transition metal compound. Although allowed the catalyst may not be necessary due to new influence of the x-ray and neutrons for carbon rehybridization and fixation.

Another aspect of the current invention is a new method of manufacturing diamond and CNT. The method involves contacting a carbon containing precursor and possibly a metal containing precursor with a x-ray and/or neutron beams; applying magnetic fields to control and concentrate the reaction media and facilitating rehybridization; applying laser oscillating field to invert the generated high spin carbon and metal atoms about useful intermediary excited states; applying external laser fields ( x-ray, YAG, UV, Xicimer, He—NE, ect.)for energetic input, excitation and stimulated chemical luminescence and condensation; and applying heating device to control the chamber temperature. All of these applications hereby listed enhance the formation of CNT and diamond for the massive production of large diamond and bulk amounts of CNT.

The inventive method advantageously selectively produces carbonaceous articles such as CNT and diamond without the need for further purification thereby minimizing the loss due to purification processes. By x-ray and neutron interactions, the product is not chemically subject to adulteration during the fabrication, the yield and selectivity are also improved with lower energy input reducing the soot generation and cost.

Embodiments of the current invention comprise forming a carbon article by contacting carbon atoms and metal atoms with a neutron and x-ray beams at elevated temperature (e.g. from 100° C. to 1000° C.) with external laser irradiation and internal population inversion while applying magnetic fields of at least 1 tesla.

Another aspect of the present invention is a method of using neutron beam for the selective and analytic production of carbonaceous articles, the method facilitates the computer controlled contacting carbon containing precursor and metal containing precursor with a neutron beam source to first form carbonaceous articles; then computerized adjusting the neutron beam energy, coherence, polarity and intensity for selectively controlling the nature of the product; collecting scattered neutrons data for product analysis. In addition to computer control of the neutron beam, computer control of laser beams, heaters, pressure generators, oscillator cavities and magnetic generators lead to effective feedback controlled production of these various carbonaceous articles. The new method for the first time provides effective computerized feedback control of the synthetic process. The method of the current invention advantageously allows the precise selectivity of the product and the in-situ observation and selection of the product with more accurate, precise product observation and correlation of synthesis conditions to product type.

Other aspects of the present invention are carbonaceous articles, e.g. diamond structures, CNT and fullerenes. Embodiments include where the articles comprise over 95% carbon with significant reduction of impurities.

Additional improvements of the present invention will become readily apparent to those skilled in this art from the following detailed description wherein embodiments of the present invention are described simply by way of illustrated of the best mode contemplated for carrying out the present invention. As will be realize, the present invention is capable of other and different embodiments, its several details are capable of modifications in various respects, all without departing from the present invention. Accordingly, the drawing and descriptions are to be regarded as illustrative in nature and not restrictive.

### DESCRIPTION OF THE INVENTION

Note intensities xray, neutrons,lasers, magnetic field, temp and pressre.

The current invention focuses and resolves various issues associated with production rate, yield and selectivity of carbonaceous articles (CNT, diamond and fullerenes) by providing a novel efficient, selective and massive synthetic technique by using neutron dynamics with x-ray optical inversion and magnetic confinement to enhance the carbonaceous production. The present invention contemplates a novel technique to selectively, efficiently and rapidly enhance the electronic fixation of carbon atoms (and possibly metal atoms) during the formation of these carbonaceous article by using x-ray, neutron and magnets in conjunction with the various HPHT, LV, AV, and CVD techniques. The invention is sophisticated in its design. It is however very effective in its use, overcoming the difficulties associated with electronic rehybridization of carbon atoms, the implications from the instability of these intermediate carbon species and the dynamics of electronic relaxation, regeneration and chemical combination associated with these states. The consequences of better production rate and selectivity with less required muscle outweigh the sophisticated and high tech nature of the invention. The present invention advantageously reduces or completely eliminates the need for harsh thermal and/or catalytic conditions for necessary carbon rehybridization, fixation and condensation that are conducive to CNT fullerene and diamond formations. For diamond, the current invention provides high concentrations of high spin carbon atoms by neutron, x-ray and fixation by magnetic stabilization and densification, thereby eliminating high-pressure requirements of older arts for diamond synthesis. Such lower thermal requirement results in lower production expenses. In addition, the present invention by polarized x-rays neutron activation provides efficient intersystem crossing of excited electrons of carbon and metal atoms, thereby eliminating high temperature collisional conditions for such high spin production. Moreover, the use of energetic neutrons from nuclear reactors and existing radioactive waste makes further use of these existing nuclear technologies beyond the energy, defense, analytic and medical technologies. This novel use of x-ray provides more application and significance to synchrotron facilities and free electron lasers. This invention discovers the use of nuclear energy and high energy core electron dynamics for material syntheses, in particular the production of extremely important super-materials, such as the diamond, CNT and fullerenes. Furthermore, the present invention advantageously enhances the production rate and selectivity to levels commensurate with large-scale industrial use. Moreover, the nature of neutrons and x-rays allows the in situ analysis of the carbonaceous articles for direct observation, manipulation of conditions and feedback-controlled synthesis of these carbonaceous super-materials.

In an embodiment of the current invention, the heating provides a mechanism for increasing the kinetic energy of carbon and metal atoms precursors. It is important to note that the heater provides background energy, however the laser contribute specific energies for driving specific dynamics for diamond and CNT sysntheses.

In accordance with the current invention, carbonaceous articles are formed by contacting carbon-containing precursors and metal containing precursors with a x-ray and neutron beams. During the formation of the carbonaceous articles, a heating element is used to maintain the temperature of the atoms. Although the heating element is necessary it is important to note that in this invention the necessary temperature (<700° C.) is significantly less than the temperature in the older arts (i.e. Plasma T>3000° C. and CVD T>700° C.). During the formation of the carbonaceous articles, a metal catalyst (atoms, cluster, nanoparticles or bulk) may or may not by supplied to facilitate the formation of the carbonaceous articles. During the formation of the carbonaceous articles under heating and x-ray neutron irradiation of carbon and metal precursors within the reactive oscillator cavity, a laser cavity may be implemented within the reaction zone to electronically populationally invert high spin carbon atoms about favorable intermediates for CNT, fullerene and diamond condensation. The lasing may be synchronized with the x-ray and neutron irradiation so as to provide triplett, quartet and pentet high spin states by the x-ray and neutron interactions and to populationally invert these various triplett, quartet and pentet high spin carbon and metal states using the internal lasing cavity. During the formation of the carbonaceous articles, magnetic fields may be applied to the cavity in the reaction chamber to assist stabilization and confinement of these various high spin carbon and metal atoms. During the formation of carbonaceous articles the pressure is controlled so as to assist chemical condensation. Higher pressures favor diamond formation. In part, the type of carbonaceous articles formed depends on the conditions of temperature; catalyst; pressure; neutronand x-ray energies; laser energy and intensity; magnetic field strength; and the resulting inverted carbon electronic states.

The carbonaceous articles manufactured in accordance with the present invention can take the form of as fiber, fibril, filament, film, particles, bulk or solid.

The apparatus for the production of fullerenes, CNTs and diamonds by the present invention includes a reaction chamber having at least one heating element, inlet and outlet ports, catalyst, pressure regulating device, laser cavity, neutron source, external lasers, and external magnetic field generator. In operation, carbon and metal containing precursors (hydrocarbon, metal compound and/or carbon-metal target) are introduced into the reaction chamber via LV, AV, CVD, hot filament, HPHT or other material sources with the x-ray and neutron beams, with the application of heat, with lasing and electronic inversion of carbon atoms, with external laser irradiation, and with magnetic field confinement. It is reasoned that the carbon and metal atoms atomize. It is reasoned that contacting the resulting carbon and metal atoms with the neutrons and polarized x-rays facilitate the electronic spin transitions of the electrons of excited carbon and metal atoms on the basis of efficient magnetic-spin interactions between polarized x-rays and neutrons with the electrons of the excited carbon and metal atoms. It is reasoned that the resulting triplett, quartet and pentet high spin carbon atoms from the intersystem crossing may be externally pumped by a laser and electronically inverted about important high-spin, carbon states for subsequent chemical condensation of these high-spin carbon atoms so as to selectively form fullerene, CNT and diamond. It is reasoned that the external pressure and magnetic field confine and stabilize the excited carbon and metal atoms within the lasing cavity to allow the neutron activated, optically induced chemical condensation of the CNT and diamond carbonaceous articles.

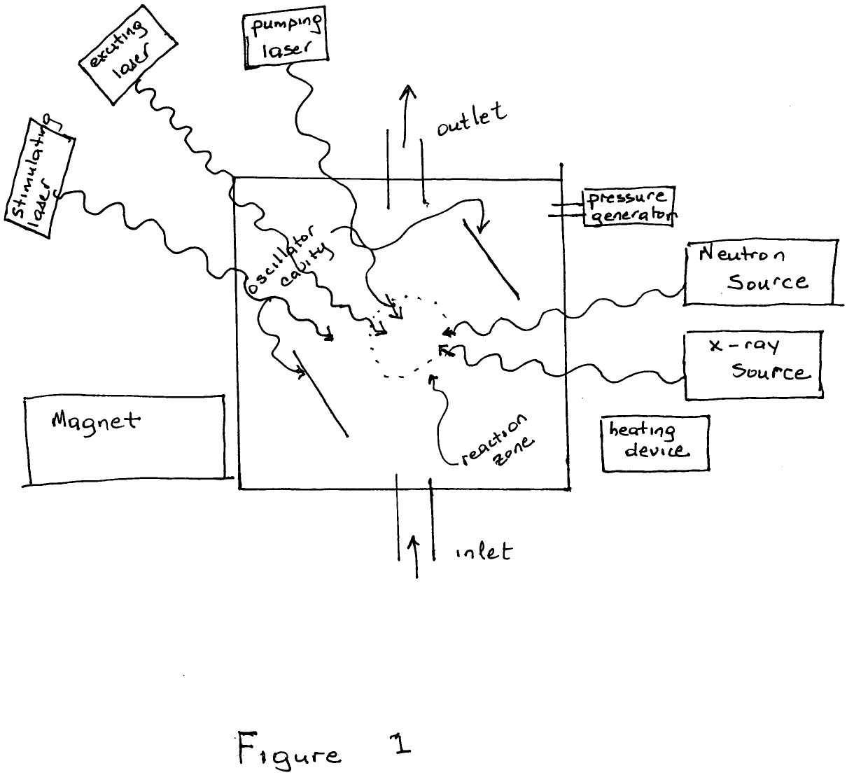

The inventive apparatus can take the physical form in a variety of parts and the arrangement of these parts. In FIG. 1, an apparatus according to the form of the current invention is illustrated. As shown in FIG. 1, the apparatus includes a reaction chamber and at least one heat element, e.g. the combination of the reaction chamber and heating element may be commercially available. The reaction chamber may be equipped with target and vaporizing laser or high voltage arcing for supplying carbon and metal atoms. The reaction chamber may be equipped with carbon and metal gaseous precursors flowing to contact a catalyst as with CVD technology. The heating element, LV, AV, and/or CVD may be of any design so long as it provides a sufficient thermal source of carbon and possibly metal atoms. The reaction chamber includes at least one port for introducing the reactants and at least one port for exit of materials.

In the form of the present invention the reaction chamber is in the fluid communication with the carbon and metal sources within or without the reaction chamber or with flowing carbon and metal precursors supplied by inlet ports. The carbon and metal sources include but are not limited to LV, AV, HPHT, hot filament and catalytic CVD. In the form of the current invention, the carbon and metal atoms flowrates are controlled by laser pulse, arc, or CVD rate ect . . . . In practice, the carbon and metal precursors may be diluted with a background gases such as hydrogen, helium or argon or other reagent gases that are currently known to promote carbonaceous article formation.

In an embodiment of the current art, the reaction chamber provides a space/time for the atomized carbon and metals to be electronically excited, electronically spin polarized, electronically inverted about excited states, electronically confined by external magnetic field and pressure for the driven chemical condensation of fullerene, CNT and diamond carbonaceous articles. The reaction chamber should be large enough to allow the internal lasing arrangement. The reaction chamber should be shaped and sized so as to facilitate carbon and metal atomization from various precursors using various methods e.g. LV, AV, and CVD. The reaction chamber should be of such to allow heating and pressurizing so as to facilitate electronic processes and subsequent chemical condensation. The reaction chamber should be of the form for sufficient residence of carbon and metal atoms for efficient contact with the spin activating polarized x-ray and neutron sources and optical population inversion about resulting triplett, quartet and pentet states. The reaction chamber should facilitate the intervention of external magnetic fields so as to confine ions and paramagnetic atoms within the lasing regions.

The reaction chamber also includes at least one additional port, e.g. exit port for exhaust, flue gases or to attach a pressure device in fluid communication with the reaction chamber, e.g. vacuum pump to reduce pressure or to increase pressure.

In accordance with the current inventive apparatus, a catalyst or metal may be disposed to the reaction chamber in the form of transition metal containing precursor compound or as a seed element in the carbon targets. The catalyst may be metal atom, metal compound, cluster, nanoparticle or bulk particles that are freely dispersed or confined to a substrate.

In an embodiment of the present invention, the catalyst provides of necessity a basis for chemically catalyzing carbon rehybridization. The catalyst may be in the form of atoms, compound, clusters, nanoparticle or macroparticles. The catalyst may be transition metal or transition metal compounds. The catalyst may be localized on substrate or uniformly disposed to the reaction zone. The temperature is fine tuned to maximize the influence of the catalyst. The x-ray irradiation is fine tuned to maximize the catalytic activity. The neutron irradiation is fine tuned to maximize the influence of the catalyst. The optical population inversion is fine tuned to maximize the influence of the catalyst. The magnetic field is fine tuned to maximize the influence of the catalyst. The pressure is fine tuned to optimize catalytic activity. Pressure ranges from 10⁻⁴ to 10⁷ atm. Temperature ranges from 25° C. to 6000° C.

In accordance with the current inventive apparatus at least one internal set-up may exist within the reaction chamber for determining a laser cavity. In the case of CVD source, at least one device may be present to laser (x-ray) irradiate the catalytic nanoparticles during their neutron activation. But here the apparatus containing homogeneous plasma/gas fluid media is consider wherein a laser cavity may be defined. The lasing device consisting of mirrors surfaces capable of enduring the harsh environment for some time and disposed within the reaction chamber and defining the reactive zone such that magnetic fields may confine the carbon and metal atoms within this reactive cavity. The technology of mirrored surfaces and the need to continually re-polish the mirror due to corrosion is important for the new invention. An external laser may pump the carbon and metal atoms to create population inversion about suitable high spin electronic states for enhanced fullerene, CNT and diamond synthesis. Laser pumping, include x-ray from free electron laser and even other x-ray sources. Any device capable of inverting the carbon and or metal atoms is suitable for the present inventive apparatus. The strength of the lasing should be so as to affect significant numbers of carbon atoms and possibly metal atoms within the cavity.

Similar as 40 but onsider x-ray description . . . x-ray intensity.

In accordance with the present inventive apparatus, at least one device or source of a neutron beam is externally irradiating the lasing cavity or substrates. The neutron source is positioned outside the reaction chamber. Any device capable of the generation of a source of neutrons can be used in the present inventive apparatus and can include spallation sources, nuclear reactor sources or radioactive waste sources. The neutron source may be continuous or pulsed also correlated or uncorrelated natures. The energy of the neutrons is such to affect the electrons of the carbon atoms and possibly the metal atoms so as to cause electronic intersystem crossing. In an embodiment of the current invention, the neutron irradiation provides a mechanism for increasing the concentrations of tripplett, quartet and pentet carbon atoms. The neutron may be spin-polarized or non-polarized. The neutrons may be from various sources. The neutron may be focused or dispersed. The neutron flux may vary only so as to influence the spin state of electrons. Neutron fluxes of 106 to 10⁵⁰/cm²-s are claimed. The neutron polarization, flux, pulse duration and or energy may be tailored according to thermal and pressure conditions in the reaction chamber for optimum yield and rates. The neutron polarization, flux, pulse duration and or energy may be tailored and synchronized to the optical pumping, population inversion and lasing in the laser cavity. The neutron polarization, flux, pulse duration and or energy may be adjusted to compatibility with the confining magnetic field. The neutron polarization, pulse duration and/or energy may be adjusted to optimize selective, massive chemical condensation of diamond, CNT and fullerenes or other carbonaceous articles. The neutron polarization, flux, pulse duration and or energy may be adjusted to analyze, manipulate and control the selective mass chemical condensation of diamond, CNT or fullerene.

In accordance with the present inventive apparatus, at least one device for generating magnetic field is placed near the reaction chamber. The device is placed external to the reaction chamber, attached on the outer surface or at a distance from the chamber. Any device capable of generating a magnetic field is suitable for this purpose.

In an embodiment of the present invention, the magnetic field provides a means for controlling paramagnetic atoms in the reaction chamber for the confining the triplett, quartet, pentet, hexet, heptet carbon and metal species within the laser cavity. Various devices may generate the magnetic field. The magnetic field intensity, direction and duration may be so as to maximize confinement, population inversion and chemical condensation. The magnetic field intensity, duration and direction may be synchronized with neutron so as to confine generate tripplett, quartet, pentet, hexet, heptet carbon and metal excited species. The magnetic field may be adjusted with regard to heat. The magnetic field may be adjusted with regard to pressure. The magnetic field may be adjusted with regard to ionizing laser. The magnetic field may be adjusted with regard to catalyst. The magnetic field may be adjusted with regard to laser cavity.

The inventive apparatus described by way of the above embodiment can be used to mass-produce carbonaceous articles, such as CNT and diamond for commercial, industrial and research applications. The various features and advantages of the present invention will become more apparent and facilitated by a description of its operation. As described above, the present inventive apparatus includes a chamber having a heating element, carbon and metal source, lasers, neutron source, internal laser cavity, and an external magnetic field generator.

Carbon precursors suitable for use in the practice of the present invention are compounds containing carbon hydrogen, hydrocarbons may be oxygen containing hydrocarbons, carbon oxides. Nonlimiting examples of such hydrocarbon compounds includes aromatic hydrocarbons, e.g. benzene, toluene . . . nonaromatic e.g. methane, ethane, . . . and oxygen containing e.g. alcohols, ketones and aldehydes. Carbon targets and electrodes, fullerenes and graphite targets.

Metal precursors suitable for use in the practice of the present invention are transition metals and compounds of transition metals. Also alloys of transition metals.

The catalyst need not by in active form before entry into the chamber so long as it can be readily activated under reaction conditions.

In practicing the present invention, carbonaceous articles are formed in the chamber by producing carbon and metal atoms from AV, LV, and CVD and other sources. Heating the carbon and metal mixture provides some kinetic energy to facilitate events for subsequent chemical condensation. Modulating the pressure in the reaction chamber also facilitates collisional events for favorable chemical condensation. Interactions between carbon and metal atoms allow some rehybridization of carbon atoms for suitable chemical condensation. Contacting carbon atoms (and maybe metal atoms for indirect influence on carbon atoms) with an external source of neutrons super-enhances the rehybridization of carbon atoms directly (via direct neutron interaction with carbon) and indirectly (via neutron metal and then metal carbon rehybridization). The neutron and less so the metal rehybridization of carbon atoms result in tripllett, quartet and pentet electronic states of carbon. The production of these high spin carbon states is synchronized with the magnetic confinement by external field. Different masses of atoms relative to neutron and different cyclotrons, manipulate to have different cyclotron directed clockwise and counterclockwise for fruitful collisions. The magnetic field captures high spin atoms and confines within the internal laser cavity. The laser cavity pumps and populationally inverts high spin carbon atoms about important excited, high-spin, hybrid carbon states for the selective chemical condensation of diamond, CNT and fullerenes. Data from scattered neutrons provide information on electronic states of excited carbon atoms. Data from excited neutrons also provide information on chemical condensed carbon states. The data are fed to a computer with logic to associate condition to carbon atomic states and to final product with the feedback control of conditions to yield desired products: CNT or diamond.

Reaction parameters include to the particular precursors; catalyst; precursor temperature; catalyst temperature; reaction pressure; residence time; feed composition, including presence and concentration of any diluent (e.g. Ar) or compounds capable of reaction with carbon to produce gaseous products (e.g. CO, H₂, H₂O); neutron energy, spin polarity, flux and direction; laser pump energy; laser cavity; oscillator conditions; external magnetic field strength and direction. It is contemplated that the reaction parameters are highly interdependent and that the appropriate combination of the reaction parameters will depend on the precursor, catalyst, neutron, laser cavity, heating, pressure and magnetic field for the article intended to be fabricated.

In practicing the present invention, the carbonaceous articles of CNT and diamond can be produced by providing a carbon and metal atom source; elevating the temperature to sufficient range tho less than in older art; contacting the carbon atoms and metal atoms at elevated temperature; controlling the pressure so as to select for CNT and diamond with fullerene at lowest pressure, then CNT slightly higher pressure and diamond at the highest pressures; irradiating the excited carbon atoms with neutrons of appropriate energy so as to facilitate intersystem crossing for triplett, quartet and pentet carbon high spin formation; laser exciting the carbon and metal atoms; confining the high spin excited carbon atoms by using external magnetic fields so as to concentrate the internal laser cavity for population inversion and chemical condensation; oscillating the carbon and metal atoms in an internal lasing chamber for population inversion about important high spin intermediate hybrid carbon states that lead to selective chemical condensation of diamond and or CNT; levitating the growing carbonaceous articles in the magnetic field; analyzing the carbon intermediates and growing carbonaceous structures during the process by using scattered neutrons as source of data; changing process parameters T, concentration, electric field, magnetic field pressure, laser irradiation, neutron irradiation, oscillation frequency so as to maximize specific carbon states and condensation of specific products i.e. CNT and diamond; using a computer to read, store and manipulate the process control and mass selective synthesis of carbonaceous articles; and allowing these activities for an effective amount of time. By an effective amount of time it is meant for that amount of time needed to produce mass quantities. The amount of time may be from hours to days depending on conditions.

The carbon concentration should be high enough to allow the catalyst, neutron, heat, laser energy, magnetic field and electric field and pressure to selectively condense CNT or diamond. The precise concentration will depend on the desired product.

The metal catalyst concentration should be high enough to allow the carbon, neutron, heat, laser energy, magnetic field, electric field and pressure to selectively condense CNT or diamond. The precise metal concentration will depend on the desired product. Neutrons and lasing allow lower metal and possibly no metal for SWCNT.

The temperature should be high enough to allow the carbon catalyst, neutrons, laser energy, magnetic field, electric field and pressure to selectively condense CNT of diamond. The precise temperature will depend on the desired product. The neutron and laser may allow higher temperature without the need to use catalyst. Higher temperature and pressure may be bad due to collisional rehybridization. Neutron and laser may allow lower temperature collisions may not be factors because carbon is hard to rehybridize low density of states.

The laser excitation should be at a wavelength that facilitates the electronic transition of carbon atoms to suitable high-energy excited states. The wavelength, intensity, pulse width, duration are process variables that are fine tuned to the desired product CNT and diamond.

The neutron beam should be so as to facilitate the intersystem crossing of carbon atoms to form tripplett, quartet and pentet states for population inversion about these high spin states and chemical condensation of diamond and CNT.

The pumping laser should be such that it excites high spin carbon and metal atoms for population inversion about high spin states.

The laser cavity may be (fabri-perot) should be adjustable so as to tune lasing frequencies about suitable energies for selective chemiluminescence associated with diamond and CNT chemical condensation from high spin triplet, quartet and pentet excited states.

The pressure device should be in fluid communication with the reaction chamber and adjustable for high pressure to vacuum so as to facilitate.

The magnetic field is optional but may be used to assist confinement of high spin carbon and metal atoms the magnetic field may separate high spin from low spin atoms providing high density of high spin carbon for diamond nucleation and growth at pressures much less than older art.

It is contemplated that the chamber housing the carbon and metal atoms be maintained so that the heat pressure, exciting laser, neutron, pump laser, oscillator, stimulating laser and possibly magnetic field and possible electric field can influence these carbon and metal atoms. The heat (temperature) and pressure of the carbon and metal are maintained below a certain range so as to reduce collisional rehybridization of carbon atoms.

In an embodiment of the present invention, CNT and or diamond can be produced by passing carbon and metal through the apparatus having pressure, temperature, exciting laser, neutron source, pump laser, oscillator, lasing cavity, chemiluminescence, stimulating laser, magnetic field, electric field. It is believed that by this process diamond and CNT may grow (chemically condense) in the internal laser/oscillator cavity.

The produced diamond and CNT can be removed by removal of magnetic levitation.

The present apparatus allows the formation of CNT and diamond without much impurity. The magnetic field suspends carbon actively as they grow.

In accordance with an embodiment of the present invention the final carbonaceous articles may be removed, separated from the metal.

### EXAMPLE

An apparatus was built by aligning the catalyst bed in a quartz tube within the furnace with a neutron source at Oak Ridge National Laboratory. The catalyst was made by forming Fe/Mo nanoparticles from Fe/Mo cluster molecules. The Fe/Mo in the nanoparticles was roughly 1-2 nm. The catalyst was placed on a silicon substrate to form the catalyst bed. The catalyst bed was placed within the quartz tube having a length of 8 ft and diameter of 25 mm. The catalyst bed was arranged at a location of the quartz tube, where the tube wall was flattened (to form irradiation window) to facilitate the in-situ laser and neutron irradiation of the interior. The quartz tube with the inserted catalyst bed was then located within the a specially designed furnace which contained two sets of diametrically aligned holes in the furnace walls at about halfway along its length. The hole pairs in the furnace walls define a line that intersect the axis of the tube furnace. The holes in the furnace allow irradiation and in-situ observation of the catalyst within the quartz tube as the furnace heats the quartz and catalyst for CNT and diamond formation. One hole pair is for neutron irradiation. The other hole pair is for laser irradiation. The furnace was heated in the range of 600° C. to 1000° C. after the pressure in the tube was adjusted and a flowing atmosphere of Ar was established. After 10 minutes of Ar purging, Ar flow was stopped and hydrogen flow was started. After 10 minutes of purging with hydrogen, simultaneously CO was introduced into the quartz tube and neutrons from a neutron source were directed through the furnace hole and through the quartz irradiation window onto the catalyst. A laser beam is focused on the catalyst bed during the neutron irradiation. The quartz is polished to act as reflecting surface. The polished quartz compartment provides a lasing cavity containing the catalyst. This lasing cavity is not useful for solid catalyst as with CVD but for laser and arc-generated plasmas the cavity may provide lasing, oscillating and populational inversion of carbon in the plasmas. For this particular example, the neutrons and laser beams were focused on the catalyst during CVD. The neutrons are deep penetrating and permeate the catalytic NP affecting both the electrons of absorbed carbon atoms and the metal lattice. These neutron-electron interactions enhance electronic spin transitions of carbon atoms that promote carbon diffusion through the catalyst and chemical precipitation as CNT and diamond. The laser in this example drives specific plasmons in the NP and phonons that facilitate carbon motion and electron interactions with neutrons for enhanced CNT and diamond formations.

Diamond and/or CNT were made by contacting methane with the catalyst while irradiating with neutrons and laser photons. Subsequent characterization of the diamond and CNT revealed high purity and faster growth rate relative to the production in the absence of neutrons and laser irradiation.

The present invention provides enabling art for the fabrication diamond and CNT articles with improved yield, purity, selectivity and efficiency.

1. A method and apparatus for producing carbon materials comprising the steps of laser exciting carbon and metal precursors, neutron activated fixation of these excited carbon atoms to form important high spin hybrid carbon excited states, optical population-inversion of these carbon atoms about these high spin states, selective and massive laser stimulated chemical luminescence and condensation of CNT, diamond and other carbonaceous articles from these various inverted carbon intermediary high spin electronic states.
